(19) United States
(12) Patent Application Publication
(10) Pub. No.: US 2018/0236729 A1
(43) Pub. Date: Aug. 23, 2018

(54) Additive Manufacturing of Three-Dimensional Objects by Depositing Runs of Material in Non-Planar Layers

(71) Applicant: Arevo, Inc., Santa Clara, CA (US)

(72) Inventor: Wiener Mondesir, Oakland, CA (US)

(73) Assignee: Arevo, Inc., Santa Clara, CA (US)

(21) Appl. No.: 15/438,559

(22) Filed: Feb. 21, 2017

(51) Int. Cl. B29C 67/00; B33Y 10/00; B33Y 30/00; B33Y 50/02

(52) U.S. Cl. CPC B29C 67/0088; B29C 67/0055; B29C 67/0085; B29K 2101/12; B33Y 30/00; B33Y 50/02; B33Y 10/00

(57) ABSTRACT

A process of additive manufacturing in which a stack of non-planar layers of material are deposited for manufacturing an object. The non-planar layers can conform to the surface of the object or not. The non-planar layers can create structurally-advantageous interior structures in the object. The contours of the non-planar layers can be different or can be the same.

### STATEMENT OF RELATED APPLICATIONS

The following patent applications are incorporated by reference for their description of how to make and use additive manufacturing system 100:
U.S. patent application Ser. No. 15/375,832, filing date Dec. 12, 2016;
U.S. patent application Ser. No. 15/232,767, filing date Aug. 9, 2016;
U.S. patent application Ser. No. 14/574,237, filing date Dec. 17, 2014; and
U.S. patent application Ser. No. 14/623,471, filing date Feb. 16, 2015.

### FIELD OF THE INVENTION

The present invention relates to additive manufacturing of three-dimensional object in general, and, more particularly, to techniques for fabricating objects with non-orthogonal surfaces and internal structures.

### BACKGROUND

Additive manufacturing is a technique for building a three-dimensional object from a mathematical model of the object. In the additive manufacturing technique called fused-deposition modeling, the object is built by feeding a thermoplastic filament into a heated extrusion head. The extrusion head heats and deposits the molten thermoplastic material as one or more runs of material. Typically, a run of material is shaped like a thread or a very thin run of toothpaste. When a run is deposited, it is just slightly above its melting point. After it is deposited, the run quickly solidifies and fuses with the runs that it touches.

Perhaps the greatest advantage of additive manufacturing is that it can build an object of any shape. To accomplish this, however, there are constraints on the sequence in which the runs can be deposited. First, each run must be supported. In other words, a run cannot be deposited on air. Therefore, each run must be deposited on:
(i) a platform that is not part of the object, or
(ii) one or more previously-deposited runs that will be part of the object, or
(iii) a temporary scaffold of support material that is not part of the object, or
(iv) any combination of i, ii, and iii.
   Second, when a three-dimensional surface is sealed, it is no longer possible to deposit a run inside of that surface. This is analogous to the situation in which once you close a box, you can't put anything into the box.

There is a general methodology that is used in additive manufacturing that satisfies these constraints and enables the building of an object of any shape. The three-dimensional model of the object is modeled as hundreds or thousands of uniformly-thick horizontal layers. Each layer is modeled as hundreds or thousands of runs and voids. The object is then built, one run at a time, one layer at a time, only in the +Z direction.

There are, however, costs and disadvantages associated with traditional additive manufacturing.

### SUMMARY OF THE INVENTION

Some embodiments of the present invention are able to manufacture three-dimensional objects without some of the costs and disadvantages for doing so in the prior art. For example, some embodiments of the present invention are able to manufacture an object by depositing a run of material to form layers that are non-planar and monotonic or non-planar and non-monotonic. This is, for example, advantageous for manufacturing objects with smooth non-planar surfaces (e.g., airplane wings, ducts, propellers, axles, etc.), objects whose external “grain” is visible and should be oriented in a particular manner, and objects that require non-planar internal structures to achieve desired mechanical properties.

The illustrative embodiment manufactures an object by depositing a run of material to form N deposition layers DL[1], . . . , DL[n], . . . , DL[N], where N is a positive integer and n is a positive integer in the range n ∈ {1, . . . , N}. Deposition layer DL[1] is deposited first, if necessary. Deposition layer DL[n+1] is deposited after and on deposition layer DL[n], and deposition layer DL[N] is deposited last, if necessary. The aggregate of deposition layers DL[1], . . . , DL[n], . . . , DL[N] constitute the object.

The parameters of deposition layers DL[1], . . . , DL[n], . . . , DL[N] equal the volume intersection of the object and archetype layers AL[1], . . . , AL[n], . . . , AL[N], respectively. Archetype layer AL[n] is a continuous function z=f(n,x,y) that is defined over the domain of the object, where x and y are real numbers in the X-Y plane. Archetype layer AL[n] resides at nominal elevation e(n) relative to the object, and archetype layer AL[n] has thickness t(n,x,y). Therefore, deposition layer DL[n] also resides at nominal elevation e(n) relative to the object and has thickness t(n,x,y) insofar as it intersects the object at coordinate <x,y,e(n)>.

Archetype layers AL[1], . . . , AL[n], . . . , AL[N] can have the same function (i.e., f(1,x,y)=f(n,x,y)=f(n+1,x,y)=f(N,x,y) for all n) or different functions (i.e., f(1,x,y)≠f(n,x,y)≠f(n+1,x,y)≠f(N,x,y)). This is advantageous, for example, when fabricating an object whose top and bottom surfaces are described by different non-planar surfaces (e.g., an airplane wing, etc.). In those cases, the archetype layer corresponding to the bottom surface might conform to the shape of the bottom surface and the archetype layer for the top surface might conform to the top surface. The intermediate archetype layers can either be planar or a family of surfaces that smoothly morph from the bottom surface to the top surface and have varying thicknesses or domains.

In accordance with the illustrative embodiment, at least one of archetype layers AL[1], . . . , AL[n], . . . , AL[N] is non-planar, and one or more of archetype layers AL[1], . . . , AL[n], . . . , AL[N] can be non-monotonic.

### BRIEF DESCRIPTION OF THE DRAWINGS

FIG. 1 depicts an illustration of the salient components of additive manufacturing system 100 in accordance with the illustrative embodiment of the present invention.

FIG. 2 depicts a flowchart of the salient tasks associated with the illustrative embodiment of the present invention.

FIG. 3A depicts a plan view of object 151, which is a regular tetrahedron without a cavity.

FIG. 3B depicts an elevation view of object 151.

FIG. 4A depicts a plan view of archetype layer 400, which equals the upper surface of object 151.

FIG. 4B depicts a front elevation view of archetype layer 400.

FIG. 4C depicts a side elevation view of archetype layer 400.

FIG. 5 depicts an elevation view of archetype layer AL[1].

FIG. 6 depicts an elevation view of archetype layer AL[50].

FIG. 7 depicts an elevation view of archetype layer AL[200].

FIG. 8A depicts a plan view of deposition layer DL[1].

FIG. 8B depicts an elevation view of deposition layer DL[1] along plane AA-AA.

FIG. 9A depicts a plan view of deposition layer DL[2].

FIG. 9B depicts an elevation view of deposition layer DL[2] along plane BB-BB.

FIG. 10A depicts a plan view of deposition layer DL[99].

FIG. 10B depicts an elevation view of deposition layer DL[99] along plane CC-CC.

FIG. 11A depicts a plan view of deposition layer DL[100].

FIG. 11B depicts an elevation view of deposition layer DL[100] along plane DD-DD.

### DETAILED DESCRIPTION

For the purposes of this specification, the following terms and their inflected forms are defined as follows:
The term “horizontal” is defined as parallel to the X-Y plane.
The term “vertical is defined as normal to the X-Y plane.
The term “height” of X is defined as the difference between the highest vertical location of X minus the lowest vertical location of X.
The term “top” of X is defined as the highest vertical location of X.
The term “bottom” of X is defined as the lowest vertical location of X.

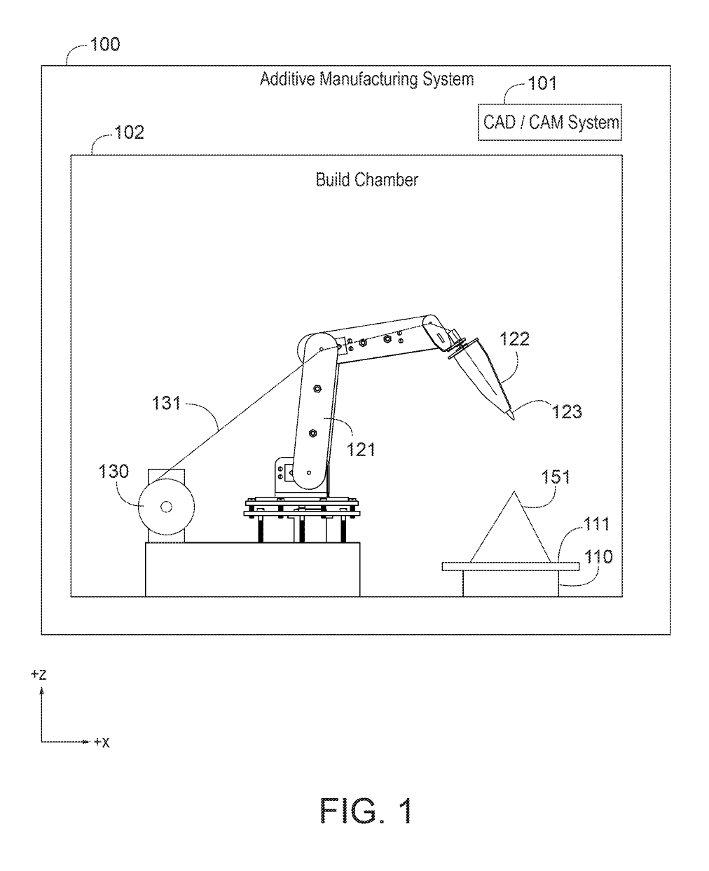

FIG. 1 depicts an illustration of the salient components of additive manufacturing system 100 in accordance with the illustrative embodiment of the present invention. Additive manufacturing system 100 comprises: CAD/CAM system 101, build chamber 102, turntable 110, deposition platform 111, robotic arm 121 (which itself comprises deposition head 122 and deposition nozzle 123), thermoplastic filament spool 130, and thermoplastic filament 131. The purpose of manufacturing system 100 is to manufacture object 151.

CAD/CAM system 101 comprises the hardware and software necessary to direct build chamber 102, control robotic arm 121, deposition head 122, deposition nozzle 123, and turntable 110 to manufacture object 151. It will be clear to those skilled in the art, after reading this disclosure, how to make and use CAM controller 101.

Build chamber 102 is a thermally-insulated, temperature-controlled environment in which object 151 is manufactured. It will be clear to those skilled in art how to make and use build chamber 102.

Turntable 110 comprises a stepper motor under the control of CAM controller 101 that is capable of rotating platform 111 (and, consequently object 151) around the Z-axis. In particular, turntable 110 is capable of:
i. rotating platform 111 clockwise around the Z-axis from any angle to any angle, and
ii. rotating platform 111 counter-clockwise around the Z-axis from any angle to any angle, and
iii. rotating platform 111 at any rate, and
iv. maintaining (statically) the position of platform 111 at any angle.
   It will be clear to those skilled in the art how to make and use turntable 110.

Platform 111 comprises hardware on which object 151 is manufactured. It will be clear to those skilled in the art how to make and use platform 111.

Robotic arm 121 is a seven-axis arm capable of depositing a run of material from any three-dimensional coordinate in the build chamber 102 to any other three-dimensional coordinate in build chamber 102 with deposition nozzle 123 at any approach angle. It will be clear to those skilled in the art how to make and use robotic arm 121.

Deposition head 122 is hardware that heats and deposits filament 131 (which may partially or wholly contain one or more fiber strands) via deposition nozzle 123.

Thermoplastic filament 131 comprises a continuous tow of carbon fiber that is impregnated with a thermoplastic, but it will be clear to those skilled in the art, after reading this disclosure, how to make and use alternative embodiments of the present invention in which thermoplastic filament 131 has a different fiber composition as described in U.S. patent application Ser. No. 14/184,010, which is incorporated by reference.

Thermoplastic filament 131 is deposited as a “run of material,” which is not shown in FIG. 1 as distinct from object 151. The physical and geometric properties of the runs of material are described below and in the accompanying figures.

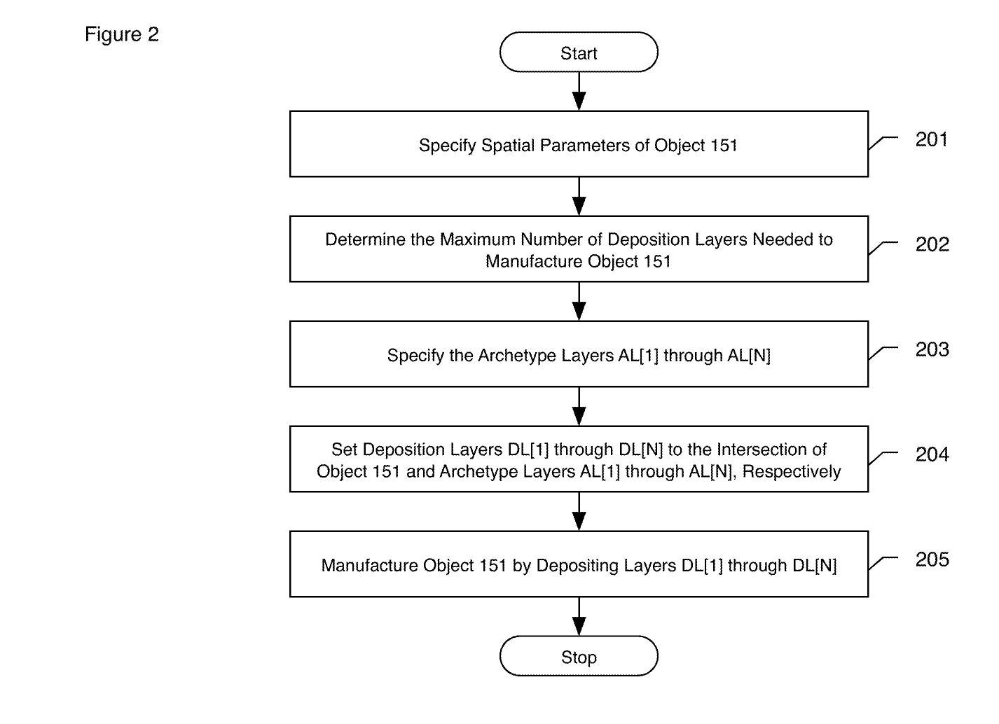

FIG. 2 depicts a flowchart of the salient tasks associated with the illustrative embodiment of the present invention.

At task 201, the spatial parameters of object 151 are specified in CAD/CAM system 101. In accordance with the illustrative embodiment, object 151 is described as a triangle mesh in well-known fashion. It will be clear to those skilled in the art, after reading this disclosure, how to make and use alternative embodiments of the present invention in which the object is described using a different convention (e.g., voxels, etc.).

As described in detail below and in the accompanying figures, object 151 is manufactured by depositing one or more runs of fiber-reinforced composite material in non-planar layers to form object 151. It will be clear to those skilled in the art, after reading this disclosure, how to make and use alternative embodiments of the present invention that use a different material.

The deposition layers are designated DL[1], . . . , DL[n], . . . , DL[N], where N is a positive integer and n is a positive integer in the range n ∈ {1, . . . , N}. Deposition layer DL[1] is deposited first (if necessary). Deposition layer DL[n+1] is deposited on deposition layer DL[n], and deposition layer DL[N] is deposited last (if necessary).

Object 151 comprises one material—the carbon fiber-reinforced thermoplastic—but it will be clear to those skilled in the art, after reading this disclosure, how to make and use alternative embodiments of the present invention that comprises two or more materials.

Object 151 does not comprise any cavities (i.e., wholly interior volumes that do not comprise material), but it will be clear to those skilled in the art, after reading this disclosure, how to make and use alternative objects of the present invention that do comprise one or more cavities.

The surfaces of object 151 are either flat or convex, but it will be clear to those skilled in the art, after reading this disclosure, how to make and use alternative embodiments of the present invention that are concave.

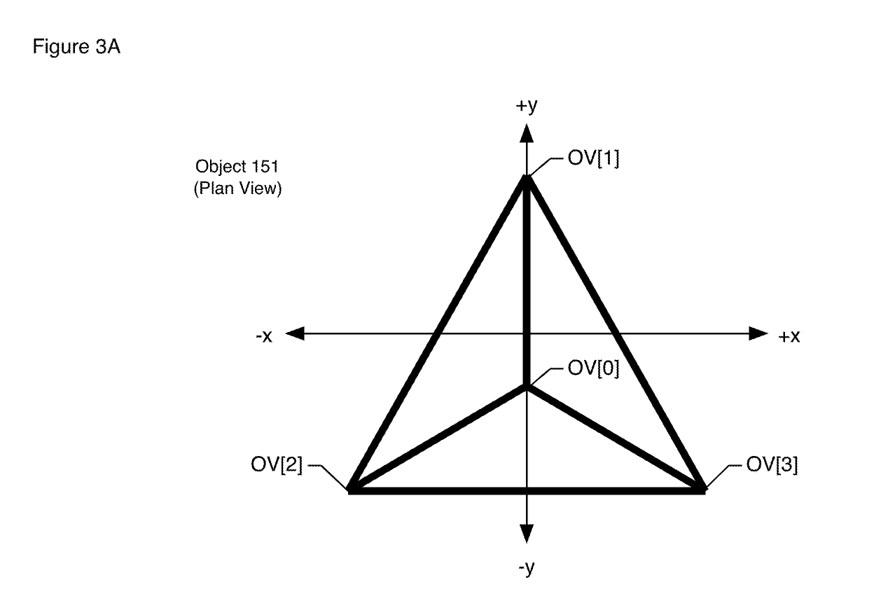

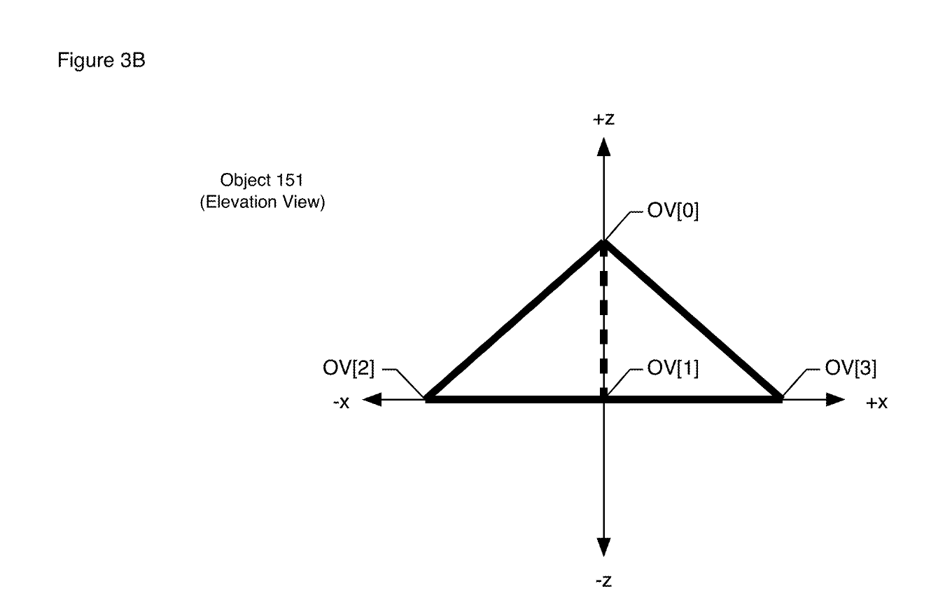

FIG. 3A depicts a plan view of object 151, which is a regular tetrahedron that is uniformly filled with fiber-reinforced thermoplastic material. FIG. 3B depicts an elevation view of object 151.

Object 151 comprises four vertices: OV[0], OV[1], OV[2], and OV[3], whose coordinates are listed in Table 1.

TABLE 1
The Values of the Coordinates in Object 151

| Vertex | X-Coordinate | Y-Coordinate | Z-Coordinate |
|---|---|---|---|
| OV[0] | OV[0, z] = 0 | OV[0, y] = −5 | OV[0, z] = 10 |
| OV[1] | OV[1, z] = 0 | OV[1, y] = 15 | OV[1, z] = 0 |
| OV[2] | OV[2, z] = −17.32 | OV[2, y] = −15 | OV[2, z] = 0 |
| OV[3] | OV[3, z] = 17.32 | OV[3, y] = −15 | OV[3, z] = 0 |

The coordinates of are specified:
i. in millimeters, and
ii. in a right-hand Cartesian coordinate system, and
iii. such that at least one vertex of object 151 is situated on the X-Y plane and no vertices of object 151 are below the X-Y plane (i.e., have negative z-coordinate values).

Although the coordinates of object 151 are specified in millimeters, it will be clear to those skilled in the art, after reading this disclosure, how to make and use alternative embodiments of the present invention that are specified in any (lowercase ‘m’) metric system and any scale.

Although the coordinates of object 151 are specified in a right-hand Cartesian coordinate system, it will be clear to those skilled in the art, after reading this disclosure, how to make and use alternative embodiments of the present invention that are specified in a different coordinate system.

Although the coordinates of object 151 are specified such that the bottom of object 151 is at the X-Y plane, it will be clear to those skilled in the art, after reading this disclosure, how to make and use alternative embodiments of the present invention in which the bottom of object 151 is not at the X-Y plane.

The triangle mesh of object 151 comprises four triangles OT[0], OT[1], OT[2], and OT[3]. Each triangle is described by an ordered-set of three vertices in right-hand-rule order so that the cross-product vector of the triangle faces into an absence of material (i.e., out of the tetrahedron). (If an object comprises a cavity, the triangles that describe the cavity are described by three vertices in right-hand-rule order so that the cross-product vector of the triangle faces into the cavity.) The four triangles are defined by the ordered set of vertices listed in Table 2.

TABLE 2
The Coordinates of the Triangles of Object 151

| | First | Second | Third |
|---|---|---|---|
| Triangle | Coordinate | Coordinate | Coordinate |
| OT[0] | OV[0] | OV[1] | OV[2] |
| OT[1] | OV[0] | OV[2] | OV[3] |
| OT[2] | OV[0] | OV[3] | OV[1] |
| OT[3] | OV[1] | OV[3] | OV[2] |

In accordance with the illustrative embodiment, the description of object 151 is “watertight”—meaning that the description of object 151 includes a surface between every volume that contains material and every volume that does not contain material.

At task 202, CAD/CAM system 101 determines the value of N, which is maximum number of layers that might be needed in order to manufacture object 151.

The thickness of deposition layer DL[n] is given by the layer thickness function t(n,x,y), where x and y are coordinates in the X-Y plane. The layer thickness function t(n,x,y) enables the thickness of each layer to be specified (e.g., all layers can have the same thickness, some layers have different thicknesses, each layer has a different thickness, etc.). Furthermore, the layer thickness function t(n,x,y) enables the thickness of each layer to be specified at each x-y coordinate.

The value of N equals the smallest value of N that satisfies the relation:

Σₙ₌₁^{N} tₘᵢₙ(n,x,y)≥H₀ (Rel. 1)

where tₘᵢₙ(n,x,y) is the minimum thickness of layer n at coordinates x,y, H₀ is the maximum width of object 151 in any dimension. The maximum width H₀ of object 151 exists at each edge and equals 22.36 millimeters. In accordance with the illustrative embodiment, the value of t(n,x,y)=0.1 millimeters for all n, x, and y. Therefore, the smallest value of N that satisfies Relation 1 is 224.

At task 203, archetype layers AL[1], . . . , AL[n], AL[N] are specified. In accordance with the illustrative embodiment, archetype layer AL[n] is a continuous function z=f(n,x,y) that is defined over at least the full domain of object 151 (i.e., the footprint of the archetype layer fully covers the footprint of the three-dimensional object).

In accordance with the illustrative embodiment, all of archetype layers AL[1], . . . , AL[n], . . . , AL[N] are non-planar. It will be clear to those skilled in the art, after reading this disclosure, how to make and use alternative embodiments of the present invention in which one or more of the archetype layers are planar and one or more of the archetype layers are non-planar.

In accordance with the illustrative embodiment, all of archetype layers AL[1], . . . , AL[n], . . . , AL[N] are non-monotonic. It will be clear to those skilled in the art, after reading this disclosure, how to make and use alternative embodiments of the present invention in which one or more of the archetype layers are monotonic.

In accordance with the illustrative embodiment, archetype layers AL[1], AL[n], . . . , AL[N] are described as a triangular mesh that satisfies the following five properties:
I. the scale is the same as that used to describe object 151, and
II. the coordinate system is the same as that used to describe object 151, and
III. f(n,x,y) is a continuous function and defined over at least the full domain of object 151, and
IV. the gradient of every position in archetype layer AL[n] must be positive (i.e., point “up”), and
V. the angle between the normal vectors of each pair of adjacent triangles in the archetype layer must be less than a threshold angle. In accordance with the illustrative embodiment, the threshold angle is 1.4 radians (≈80 degrees), but it will be clear to those skilled in the art, after reading this disclosure, how to make and use alternative embodiments of the present invention in which the threshold has a different value.

In accordance with the illustrative embodiment of the present invention, all N archetype layers AL[1], . . . , AL[n], . . . , AL[N] are the same function (i.e., f(n,x,y)=f(n+1,x,y) for all n). It will be clear to those skilled in the art, after reading this disclosure, how to make and use alternative embodiments of the present invention in which one or more archetype layers are a different function than one or more other archetype layers (e.g., f(1,x,y)≠f(n,x,y)≠f(n+1,x,y)≠f(n,x,y)).

In accordance with the illustrative embodiment, the thickness of archetype layer AL[n] is specified by the continuous function Δz=t(n,x,y). To simplify the discussion of the illustrative embodiment and the figures, the function t(n,x,y)=0.1 millimeters for all n, x, and y. It will be clear to those skilled in the art, after reading this disclosure, how to make and use alternative embodiments of the present invention in which t(n,x,y) is any function.

In accordance with the illustrative embodiment of the present invention, archetype layer AL[n] has a nominal elevation e(n) of:

z=e(n)=f(n, 0,0) (Eq. 1)

Therefore, archetype layer AL[1] has the lowest nominal elevation z=e(1)=f(1,0,0)=0.1 millimeters; archetype layer AL[n+1] has a higher nominal elevation than archetype layer AL[n] (i.e., e(n+1)>e(n), and archetype layer AL[N] has the highest nominal elevation z=e(N)=f(N,0,0)=22.4 millimeters.

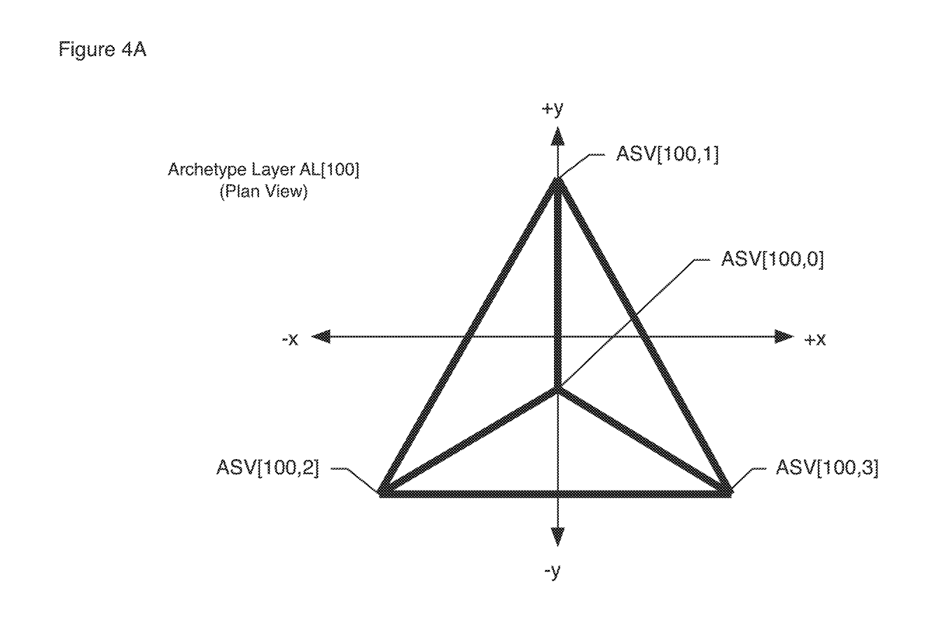

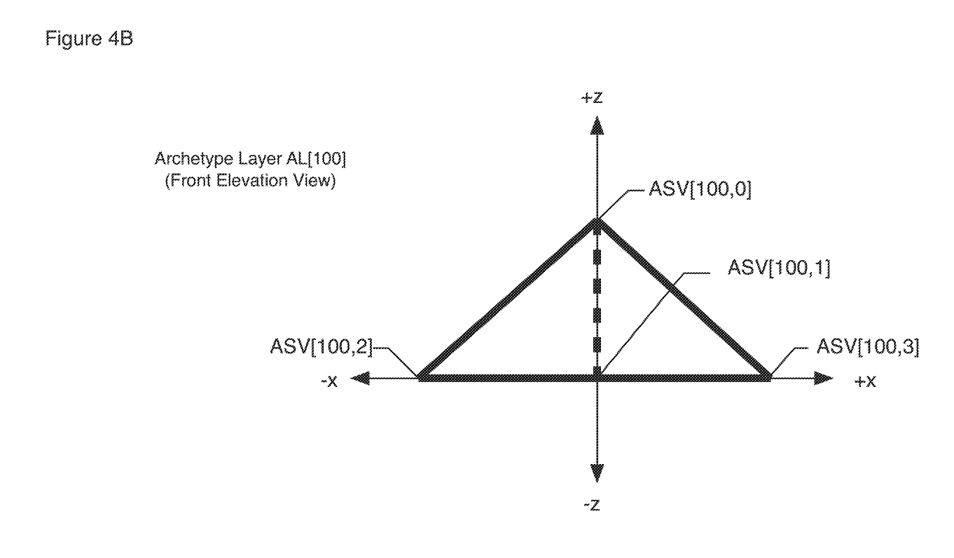

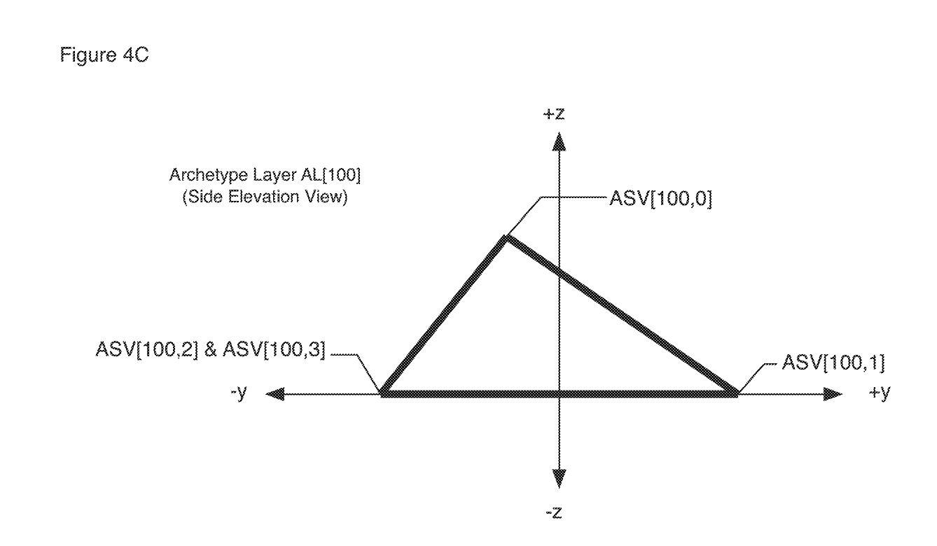

FIG. 4A depicts a plan view of archetype layer AL[100], which equals the upper surface of object 151. The domain of archetype layer AL[100] can be seen in the plan view of archetype layer 400. FIG. 4B depicts a front elevation view of archetype layer AL[100]. FIG. 4C depicts a front elevation view of archetype layer AL[100]. The contour of archetype layer AL[100] can be seen in the front and side elevation views of archetype layer AL[100].

Although archetype layer AL[100] equals the upper surface of object 151, it will be clear to those skilled in the art, after reading this disclosure, how to make and use alternative embodiments of the present invention in which archetype layer AL[n] has any contour. Furthermore, it will be clear to those skilled in the art, after reading this disclosure, how to make and use alternative embodiments of the present invention in which the contour of archetype layer AL[n] is unrelated to the shape of the object.

Archetype layer AL[n] comprises vertices: ASV[n,1], . . . , ASV[n,v], . . . , ASV[n,V], where:
V is a positive integer, and
v is a positive integer in the range v ∈ {1, . . . , V}.
   In accordance with the illustrative embodiment V=4. The coordinates of vertices ASV[n,0], ASV[n,1], ASV[n,2], and ASV[n,3] are listed in Table 3.

TABLE 3
The Values of the Coordinates in Archetype layer AL[n]

| Vertex | X-Coordinate | Y-Coordinate | Z-Coordinate |
|---|---|---|---|
| ASV[n, 0] | ASV[n, 0, z] = | ASV[n, 0, y] = −5 | ASV[n, 0, z] = 10 |
| | 0.0 | | |
| ASV[n, 1] | ASV[n, 1, z] = | ASV[n, 1, y] = 15 | ASV[n, 0, z] = 0 |
| | 0.0 | | |
| ASV[n, 2] | ASV[n, 2, z] = | ASV[n, 2, y] = −15 | ASV[n, 0, z] = 0 |
| | −17.32 | | |
| ASV[n, 3] | ASV[n, 3, z] = | ASV[n, 3, y] = −15 | ASV[n, 0, z] = 0 |
| | 17.32 | | |

Archetype layer AL[n] comprises three triangles AST[n,0], AST[n,1], and AST[n,2]. The three triangles are defined by the ordered set of vertices listed in Table 4.

TABLE 4
The Coordinates of the Triangles Archetype layer AL[n]

| | First | Second | Third |
|---|---|---|---|
| Triangle | Coordinate | Coordinate | Coordinate |
| AST[n, 0] | ASV[n, 0] | ASV[n, 1] | ASV[n, 2] |
| AST[n, 1] | ASV[n, 0] | ASV[n, 2] | ASV[n, 3] |
| AST[n, 2] | ASV[n, 0] | ASV[n, 3] | ASV[n, 1] |

It will be clear to those skilled in the art, after reading this disclosure, how to make and use alternative embodiments of the present invention that use any archetype layer that satisfies Properties I, II, III, IV, and V regardless of whether the archetype layer bears any similarity to the object to be manufactured.

For the following reasons, archetype layer 400 satisfies the above six properties:

Property I—archetype layer AL[n] is specified in millimeters.

Property II—archetype layer AL[n] is specified in a right-hand Cartesian coordinate system.

Property III—archetype layer AL[n] satisfies Property IV because the archetype layer is continuous and defined for the entire domain of object 151 (from Vertex OV[1] to Vertex OV[2] to Vertex OV[3]).

Property IV—archetype layer AL[n] satisfies Property V because the Z-axis component of the normal vector for each of triangles AST[0], AST[1], and AST[2] is positive, as can be seen in Table 3.

Property V—the angle between the normal vectors for each pair of adjacent triangles in archetype layer AL[n] is shown in Table 5.

TABLE 5
The Angle Between the Normal Vectors for Each Pair of Adjacent
Triangles in Archetype layer AL[n]

| Triangle Pair | Angle |
|---|---|
| AST[n, 0] & AST[n, 1] | ≈1.3 radians (≈75 degrees) |
| AST[n, 1] & AST[n, 2] | ≈1.3 radians (≈75 degrees) |
| AST[n, 2] & AST[n, 0] | ≈1.3 radians (≈75 degrees) |

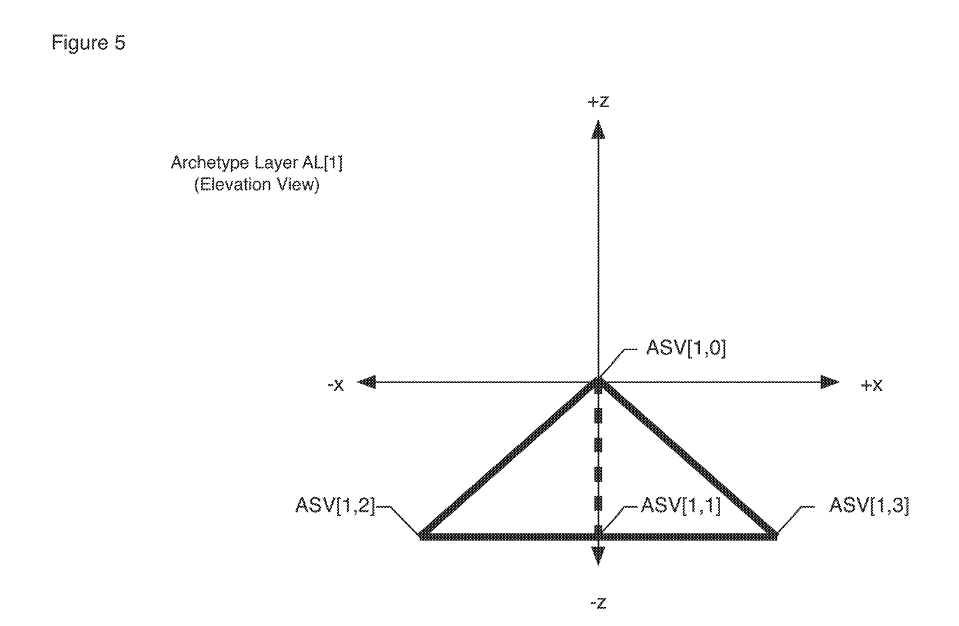

In accordance with the illustrative embodiment, the coordinates for archetype layer AL[1] are listed in Table 6 (and depicted in FIG. 5).

TABLE 6
The Values of the Coordinates in Archetype layer AL[1]

| Vertex | X-Coordinate | Y-Coordinate | Z-Coordinate |
|---|---|---|---|
| ASV[1, 0] | ASV[1, 0, z] = | ASV[1, 0, y] = −5 | ASV[1, 0, z] = 0.1 |
| | 0.0 | | |
| ASV[1, 1] | ASV[1, 1, z] = | ASV[1, 1, y] = 15 | ASV[1, 1, z] = |
| | 0.0 | | −9.9 |
| ASV[1, 2] | ASV[1, 2, z] = | ASV[1, 2, y] = −15 | ASV[1, 2, z] = |
| | −17.32 | | −9.9 |
| ASV[1, 3] | ASV[1, 3, z] = | ASV[1, 3, y] = −15 | ASV[1, 3, z] = |
| | 17.32 | | −9.9 |

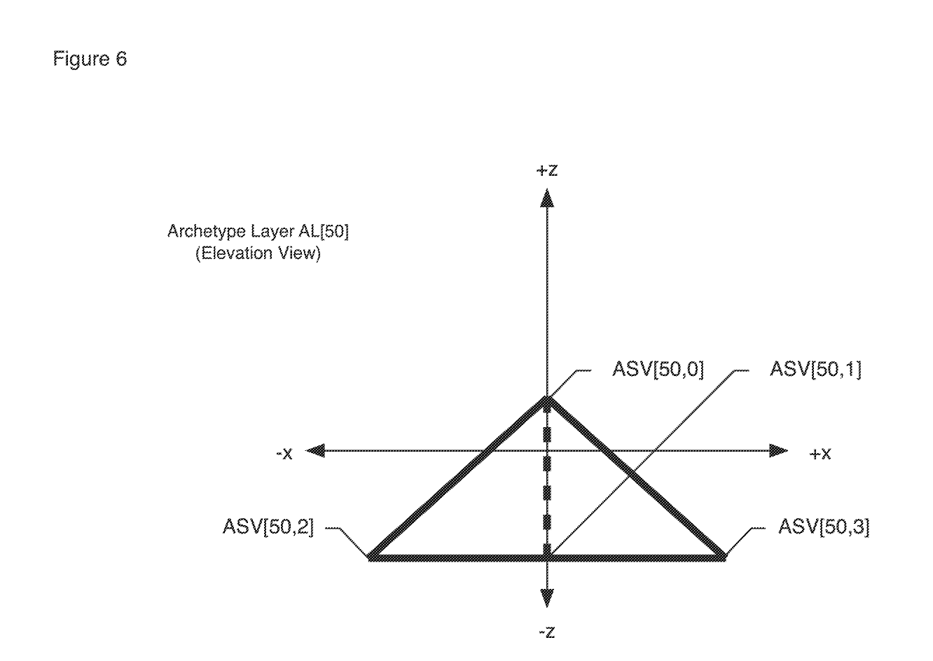

As another example, the coordinates for archetype layer AL[50] are listed in Table 7 (and depicted in FIG. 6).

TABLE 7
The Values of the Coordinates in Archetype layer AL[50]

| Vertex | X-Coordinate | Y-Coordinate | Z-Coordinate |
|---|---|---|---|
| ASV[50, 0] | ASV[50, 0, z] = 0.0 | ASV[50, 0, y] = −5 | ASV[50, 0, z] = 5.0 |
| ASV[50, 1] | ASV[50, 1, z] = 0.0 | ASV[50, 1, y] = 15 | ASV[50, 1, z] = −5.0 |
| ASV[50, 2] | ASV[50, 2, z] = −17.32 | ASV[50, 2, y] = −15 | ASV[50, 2, z] = −5.0 |
| ASV[50, 3] | ASV[50, 3, z] = 17.32 | ASV[50, 3, y] = −15 | ASV[50, 3, z] = −5.0 |

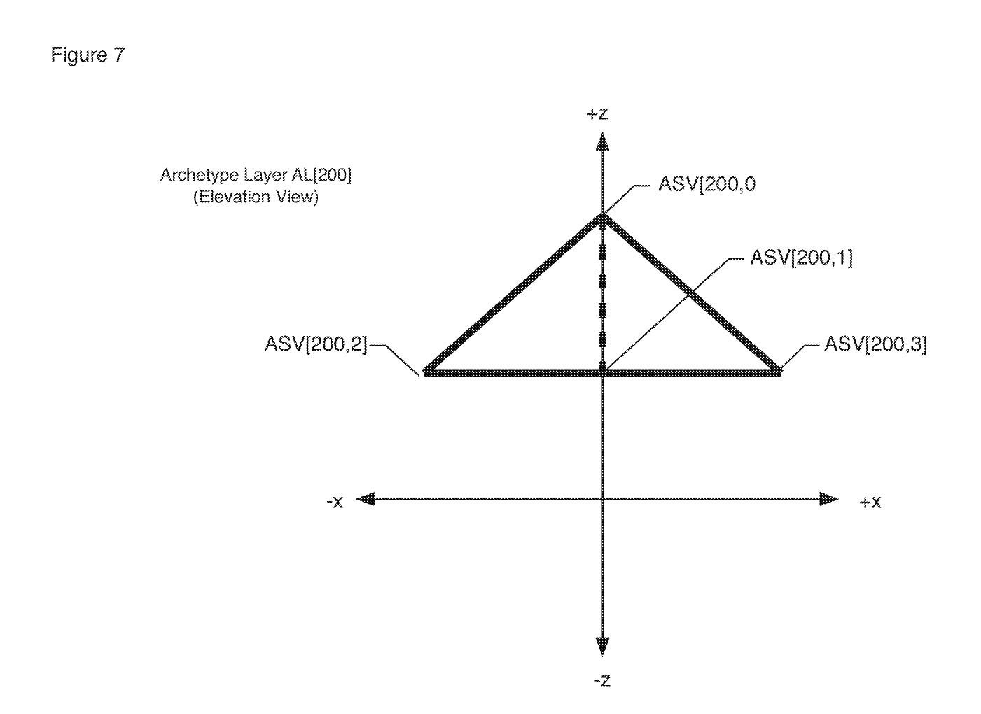

As another example, the coordinates for archetype layer AL[200] are listed in Table 8 (and depicted in FIG. 7).

TABLE 8
The Values of the Coordinates in Archetype layer AL[200]

| Vertex | X-Coordinate | Y-Coordinate | Z-Coordinate |
|---|---|---|---|
| ASV[200, 0] | ASV[200, 0, z] = 0.0 | ASV[200, 0, y] = −5 | ASV[200, 0, z] = |
| | | | 20.0 |
| ASV[200, 1] | ASV[200, 1, z] = 0.0 | ASV[200, 1, y] = 15 | ASV[200, 1, z] = |
| | | | 10.0 |
| ASV[200, 2] | ASV[200, 2, z] = −17.32 | ASV[200, 2, y] = −15 | ASV[200, 2, z] = |
| | | | 10.0 |
| ASV[200, 3] | ASV[200, 3, z] = 17.32 | ASV[200, 3, y] = −15 | ASV[200, 3, z] = |
| | | | 10.0 |

At task 204, CAD/CAM system 101 determines the domain of deposition layers DL[1], . . . , DL[n], . . . , DL[N]. In particular, deposition layer DL[n] equals the volume intersection of archetype layer AL[n] and object 151. It will be clear to those skilled in the art how to determine the volume intersection of archetype layer AL[n] and object 151.

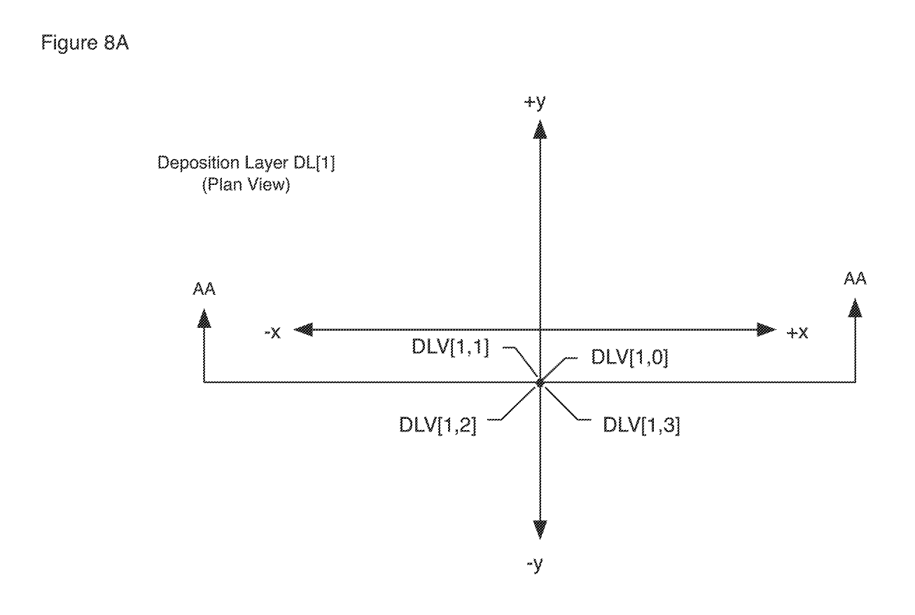

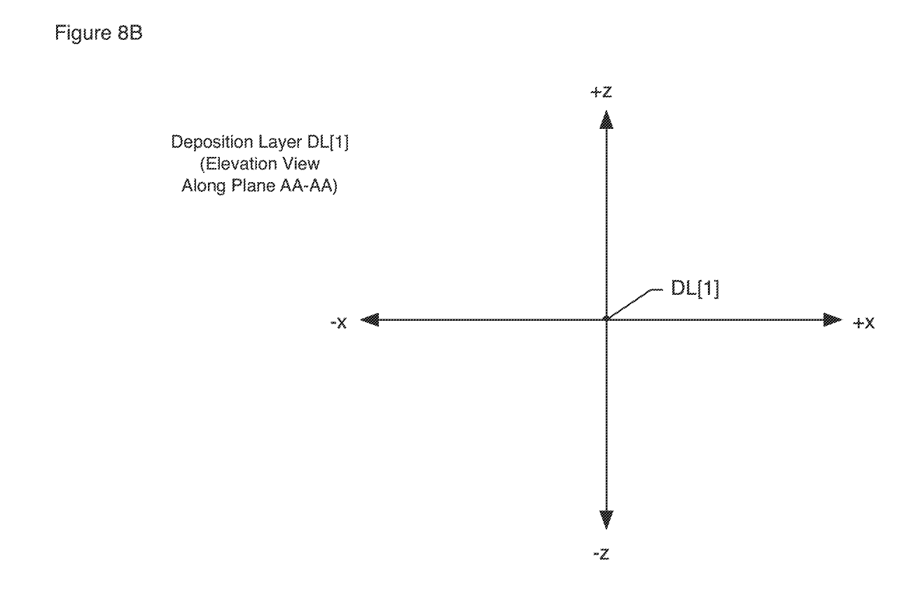

The domain of deposition layer DL[1] is described by three triangles: DLT[1,0]. DLT[1,1], and DLT[1,2] and four vertices DLV[1,0], DLV[1,1], DLV[1,2], and DLV[1,3]. The coordinates associated with each triangle are listed in Table 8 and depicted in FIGS. 8A and 8B.

TABLE 8
The Coordinates of the Triangles in Deposition layer DL[1]

| | First | Second | Third |
|---|---|---|---|
| Triangle | Coordinate | Coordinate | Coordinate |
| DLT[1, 0] | DLV[1, 0] | DLV[1, 1] | DLV[1, 2] |
| DLT[1, 1] | DLV[1, 0] | DLV[1, 2] | DLV[1, 3] |
| DLT[1, 2] | DLV[1, 0] | DLV[1, 3] | DLV[1, 1] |

The values of the coordinates in the triangles in deposition layer DL[1] are listed in Table 9.

TABLE 9
The Values of the Coordinates in Deposition layer DL[1]

| Vertex | X-Coordinate | Y-Coordinate | Z-Coordinate |
|---|---|---|---|
| DLV[1, 0] | DLV[1, 0, z] = 0.00 | DLV[1, 0, y] = −5.00 | DLV[1, 0, z] = 0.05 |
| DLV[1, 1] | DLV[1, 1, z] = 0.00 | DLV[1, 1, y] = −4.80 | DLV[1, 1, z] = −0.05 |
| DLV[1, 2] | DLV[1, 2, z] = −0.17 | DLV[1, 2, y] = −5.10 | DLV[1, 2, z] = −0.05 |
| DLV[1, 3] | DLV[1, 3, z] = 0.17 | DLV[1, 3, y] = −5.10 | DLV[1, 3, z] = −0.05 |

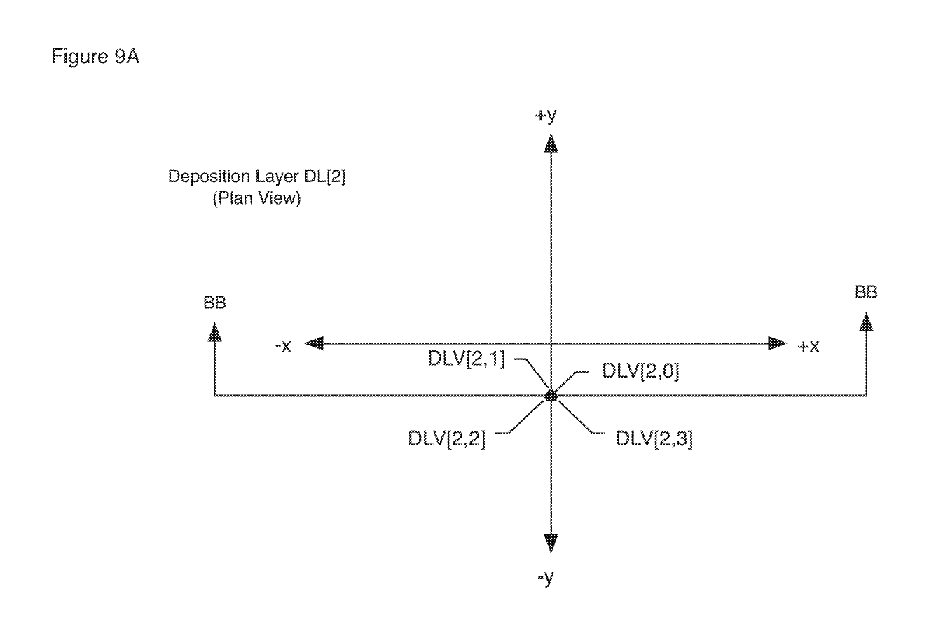

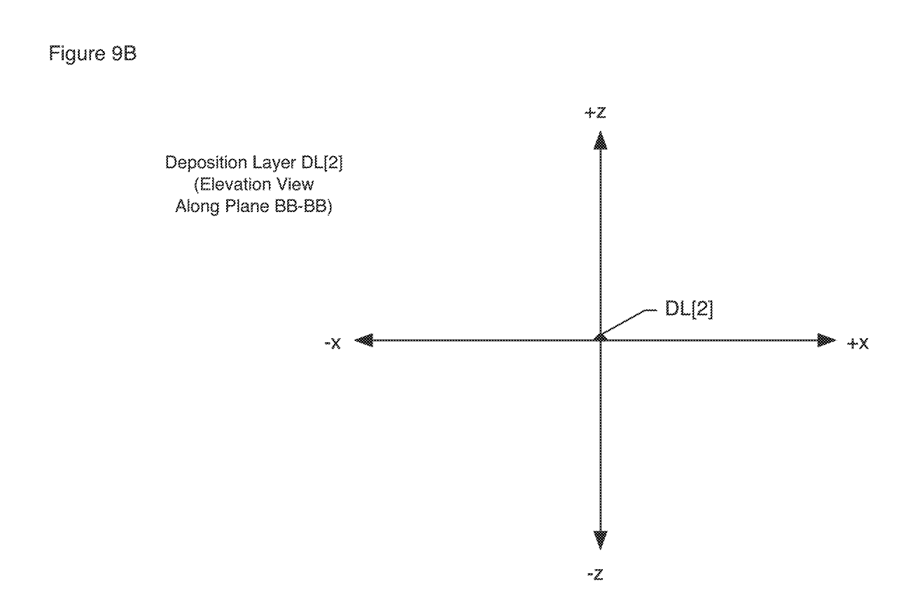

The domain of deposition layer DL[2] is described by three triangles: DLT[2,0]. DLT[2,1], and DLT[2,2] and four vertices DLV[2,0], DLV[2,1], DLV[2,2], and DLV[2,3]. The coordinates associated with each triangle are listed in Table 10 and depicted in FIGS. 9A and 9B.

TABLE 10
The Coordinates of the Triangles in Deposition layer DL[2]

| | First | Second | Third |
|---|---|---|---|
| Triangle | Coordinate | Coordinate | Coordinate |
| DLT[2, 0] | DLV[2, 0] | DLV[2, 1] | DLV[2, 2] |
| DLT[2, 1] | DLV[2, 0] | DLV[2, 2] | DLV[2, 3] |
| DLT[2, 2] | DLV[2, 0] | DLV[2, 3] | DLV[2, 1] |

The values of the coordinates in the triangles in deposition layer DL[2] are listed in Table 11.

TABLE 11
The Values of the Coordinates in Deposition layer DL[2]

| Vertex | X-Coordinate | Y-Coordinate | Z-Coordinate |
|---|---|---|---|
| DLV[2, 0] | DLV[2, 0, z] = 0.00 | DLV[2, 0, y] = −5.00 | DLV[2, 0, z] = 0.10 |
| DLV[2, 1] | DLV[2, 1, z] = 0.00 | DLV[2, 1, y] = −4.60 | DLV[2, 1, z] = −0.10 |
| DLV[2, 2] | DLV[2, 2, z] = −0.35 | DLV[2, 2, y] = −5.20 | DLV[2, 2, z] = −0.10 |
| DLV[2, 3] | DLV[2, 3, z] = 0.35 | DLV[2, 3, y] = −5.20 | DLV[2, 3, z] = −0.10 |

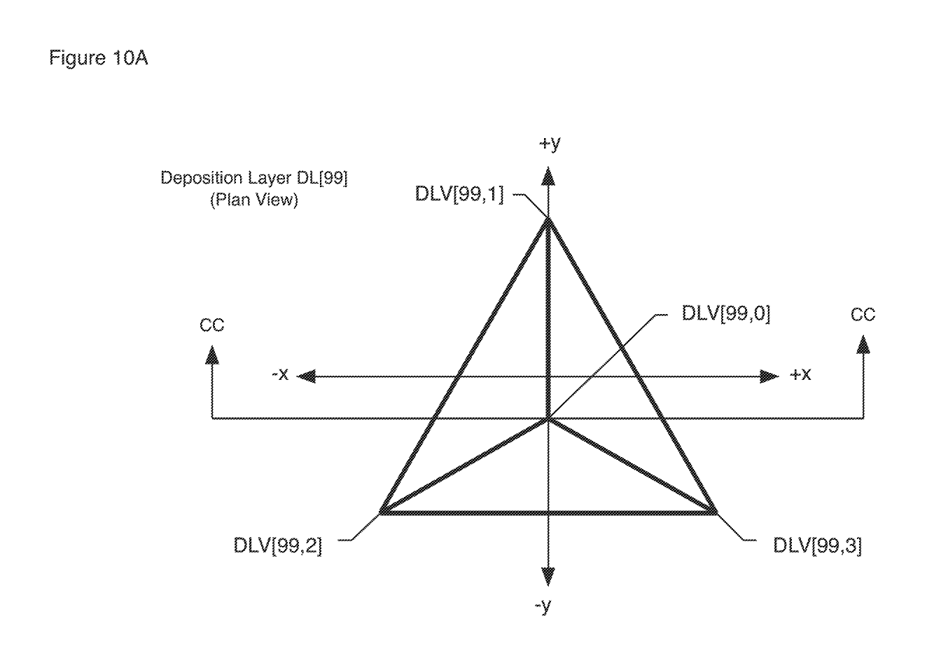

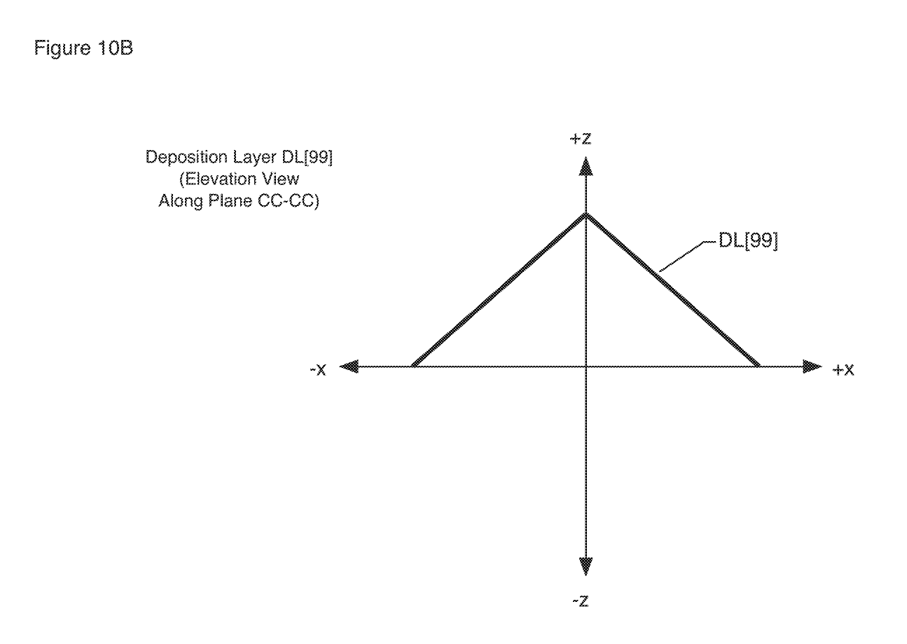

The domain of deposition layer DL[99] is described by three triangles: DLT[99,0]. DLT[99,1], and DLT[99,2] and four vertices DLV[99,0], DLV[99,1], DLV[99,2], and DLV[99,3]. The coordinates associated with each triangle are listed in Table 12 and depicted in FIGS. 10A and 10B.

TABLE 12
The Coordinates of the Triangles in Deposition layer DL[99]

| | First | Second | Third |
|---|---|---|---|
| Triangle | Coordinate | Coordinate | Coordinate |
| DLT[99, 0] | DLV[99, 0] | DLV[99, 1] | DLV[99, 2] |
| DLT[99, 1] | DLV[99, 0] | DLV[99, 2] | DLV[99, 3] |
| DLT[99, 2] | DLV[99, 0] | DLV[99, 3] | DLV[99, 1] |

The values of the coordinates in the triangles in deposition layer DL[99] are listed in Table 13.

TABLE 13
The Values of the Coordinates in Deposition layer DL[99]

| Vertex | X-Coordinate | Y-Coordinate | Z-Coordinate |
|---|---|---|---|
| DLV[99, 0] | DLV[99, 0, z] = 0.00 | DLV[99, 0, y] = −5.00 | DLV[99, 0, z] = 4.95 |
| DLV[99, 1] | DLV[99, 1, z] = 0.00 | DLV[99, 1, y] = 14.80 | DLV[99, 1, z] = −4.95 |
| DLV[99, 2] | DLV[99, 2, z] = −17.15 | DLV[99, 2, y] = −14.90 | DLV[99, 2, z] = −4.95 |
| DLV[99, 3] | DLV[99, 3, z] = 17.15 | DLV[99, 3, y] = −14.90 | DLV[99, 3, z] = −4.95 |

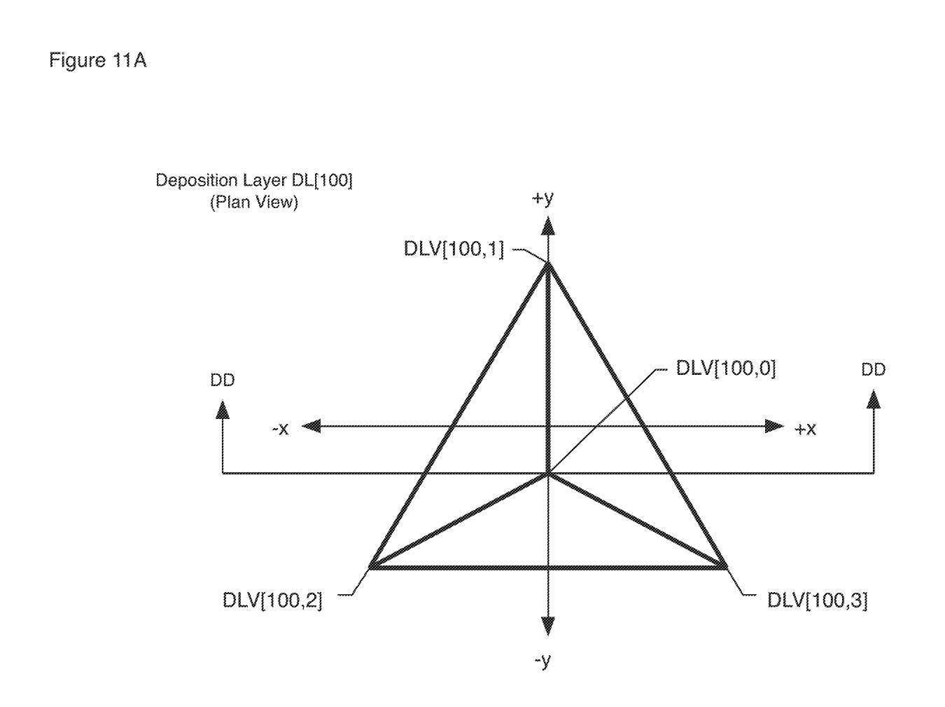

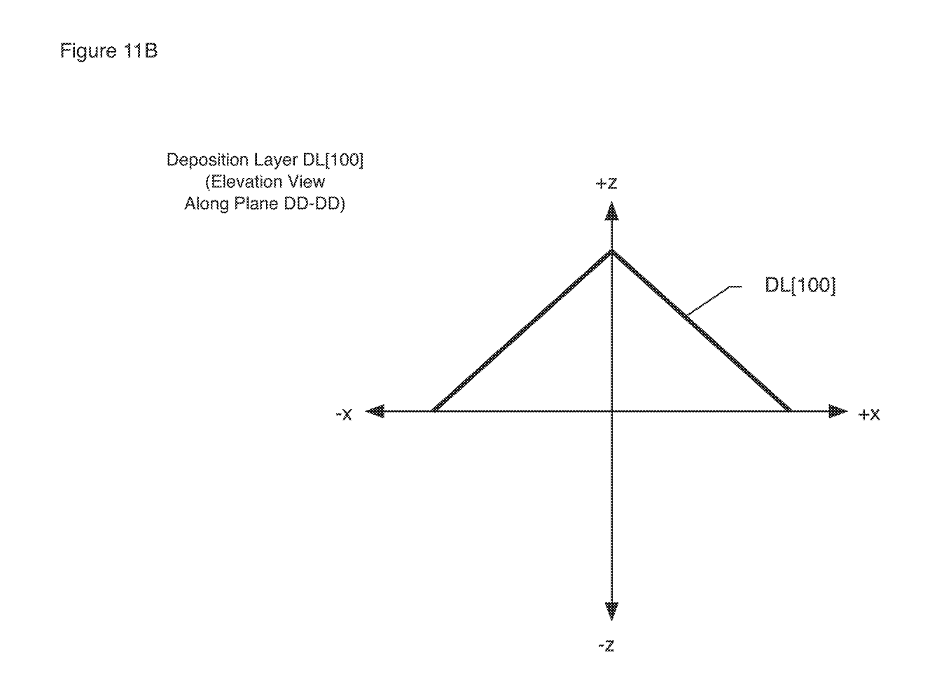

The domain of deposition layer DL[100] is described by three triangles: DLT[100,0]. DLT[100,1], and DLT[100,2] and four vertices DLV[100,0], DLV[100,1], DLV[100,2], and DLV[100,3]. The coordinates associated with each triangle are listed in Table 14 and depicted in FIGS. 11A and 11B.

TABLE 14
The Coordinates of the Triangles in Deposition layer DL[100]

| | First | Second | Third |
|---|---|---|---|
| Triangle | Coordinate | Coordinate | Coordinate |
| DLT[100, 0] | DLV[100, 0] | DLV[100, 1] | DLV[100, 2] |
| DLT[100, 1] | DLV[100, 0] | DLV[100, 2] | DLV[100, 3] |
| DLT[100, 2] | DLV[100, 0] | DLV[100, 3] | DLV[100, 1] |

The values of the coordinates in the triangles in deposition layer DL[100] are listed in Table 15.

TABLE 15
The Values of the Coordinates in Deposition layer DL[100]

| Vertex | X-Coordinate | Y-Coordinate | Z-Coordinate |
|---|---|---|---|
| DLV[100, 0] | DLV[100, 0, z] = 0.0 | DLV[100, 0, y] = −5 | DLV[100, 0, z] = 5.0 |
| DLV[100, 1] | DLV[100, 1, z] = 0.0 | DLV[100, 1, y] = 15 | DLV[100, 1, z] = −5.0 |
| DLV[100, 2] | DLV[100, 2, z] = −17.32 | DLV[100, 2, y] = −15 | DLV[100, 2, z] = −5.0 |
| DLV[100, 3] | DLV[100, 3, z] = 17.32 | DLV[100, 3, y] = −15 | DLV[100, 3, z] = −5.0 |

The domains of deposition layers DL[101] through DL[224] are empty because the volume intersection of archetype layers AL[ 101] through AL[224] and object 151 is empty.

At task 205, additive manufacturing system 100 deposits one continuous run of material to form layers DL[1], . . . , DL[n], . . . , DL[N]. It will be clear to those skilled in the art, after reading this disclosure, how to make and use alternative embodiments of the present invention in which two or more runs of material are used to manufacture object 151. For example, in some embodiments of the present invention, one run of material is deposited to form deposition layer DL[n] and a second run of material is deposited to form deposition layer DL[n+1].

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A process for additive manufacturing of a three dimensional article of manufacture, the process comprising:
depositing a first run of material to form a first deposition layer DL[n], wherein the first deposition layer DL[n] equals the volume intersection of a first archetype layer z=f(n,x,y) and the article of manufacture, wherein the first archetype layer z=f(n,x,y) is non-planar; and
depositing a second run of material to form a second deposition layer DL[n+1], wherein the second deposition layer DL[n] equals the volume intersection of a second archetype layer z=f(n+1,x,y) and the article of manufacture;
wherein n is a positive integer and x, y, and z are real numbers;
wherein f(n,x,y)=f(n+1,x,y); and
wherein the first run of material and the second run of material are of one continuous run of material.

2. (canceled)

3. The process of claim 1 wherein f(n,x,y)≠f(n+1,x,y)

4. The process of claim 1 further comprising:
depositing a third run of material to form a third deposition layer DL(n+2) on the second deposition layer DL[n+2], wherein the third deposition layer DL[n+2] equals the volume intersection of a third archetype layer z=f(n+2,x,y) and the article of manufacture, wherein the third archetype layer z=f(n+2,x,y) is non-planar.

5. The process of claim 4 wherein the first archetype layer z=f(n,x,y) is at a first nominal elevation e(n) relative to the article of manufacture, the second archetype layer z=f(n+1,x,y) is at a second nominal elevation e(n+1) relative to the article of manufacture, and the third archetype layer z=f(n+2,x,y) is at a third nominal elevation e(n+2) relative to the article of manufacture; and
wherein e(n+2)−e(n+1)=e(n+1)−e(n).

6. The process of claim 4 wherein the first archetype layer z=f(n,x,y) is at a first nominal elevation e(n) relative to the article of manufacture, the second archetype layer z=f(n+1,x,y) is at a second nominal elevation e(n+1) relative to the article of manufacture, and the third archetype layer z=f(n+2,x,y) is at a third nominal elevation e(n+2) relative to the article of manufacture; and
wherein e(n+2)−e(n+1)=e(n+1)−e(n).

7. The process of claim 1 wherein the second archetype layer z=f(n+1,x,y) is non-planar.

8. (canceled)

9. The process of claim 1 wherein the thickness of first deposition layer DL[n] is described by the function t(n,x,y), and wherein the function comprises a volume that is concave.

10. The process of claim 1 wherein the thickness of first deposition layer DL[n] is described by the function t(n,x,y), and wherein the function comprises a triangular prism.

11. An article of manufacture comprising:
a first run of material deposited in a first deposition layer DL[n], wherein the first deposition layer DL[n] equals the volume intersection of a first archetype layer z=f(n,x,y) and the article of manufacture, wherein the first archetype layer z=f(n,x,y) is non-planar; and
a second run of material deposited in a second deposition layer DL[n+1] on the first deposition layer DL[n], wherein the second deposition layer DL[n+1] equals the volume intersection of a second archetype layer z=f(n+1,x,y) and the article of manufacture;
wherein n is a positive integer and x, y, and z are real numbers;
wherein f(n,x,y)=f(n+1,x,y); and
wherein the first run of material and the second run of material are of one continuous run of material.

12. (canceled)

13. The article of claim 11 wherein f(n,x,y)≠f(n+1,x,y).

14. The article of claim 11 further comprising:
a third run of material deposited in a third deposition layer DL[n+2] on the second deposition layer DL[n+1], wherein the third deposition layer DL[n+2] equals the volume intersection of a third archetype layer z=f(n+2,x,y) and the article of manufacture, wherein the third archetype layer z=f(n+2,x,y) is non-planar.

15. The article of claim 14 wherein the first archetype layer z=f(n,x,y) is at a first nominal elevation e(n) relative to the article of manufacture, the second archetype layer z=f(n+1,x,y) is at a second nominal elevation e(n+1) relative to the article of manufacture, and the third archetype layer z=f(n+2,x,y) is at a third nominal elevation e(n+2) relative to the article of manufacture; and
wherein e(n+2)−e(n+1)=e(n+1)−e(n).

16. The article of claim 14 wherein the first archetype layer z=f(n,x,y) is at a first nominal elevation e(n) relative to the article of manufacture, the second archetype layer z=f(n+1,x,y) is at a second nominal elevation e(n+1) relative to the article of manufacture, and the third archetype layer z=f(n+2,x,y) is at a third nominal elevation e(n+2) relative to the article of manufacture; and
wherein e(n+2)−e(n+1)≠e(n+1)−e(n).

17. The article of claim 11 wherein the second archetype layer z=f(n+1,x,y) is non-planar.

18. (canceled)

19. The process of claim 11 wherein the thickness of first deposition layer DL[n] is described by the function t(n,x,y), and wherein the function comprises a volume that is concave.

20. The process of claim 11 wherein the thickness of first deposition layer DL[n] is described by the function t(n,x,y), and wherein the function comprises a triangular prism.
